(19) United States
(12) Patent Application Publication
(10) Pub. No.: US 2017/0369313 A1
(43) Pub. Date: Dec. 28, 2017

(54) PROCESS FOR STEAM REFORMING NATURAL GAS, HAVING TWO COMBUSTION CHAMBERS GENERATING HOT FUMES SUPPLYING THE NECESSARY HEAT TO THE PROCESS AND CONNECTED IN SERIES OR IN PARALLEL

(71) Applicant: IFP Energies Nouvelles, Rueil-Malmaison Cedex (FR)

(72) Inventors: Florent GUILLOU, Ternay (FR); Karine SURLA, Saint Cyr Sur Le Rhone (FR); Beatrice FISCHER, Lyon (FR); Jean-Louis AMBROSINO, Ternay (FR)

(73) Assignee: IFP Energies Nouvelles, Rueil-Malmaison Cedex (FR)

(21) Appl. No.: 15/630,989

(22) Filed: Jun. 23, 2017

(30) Foreign Application Priority Data
Jun. 28, 2016 (FR) 1656017

(51) Int. Cl. C01B 3/48; C01B 3/56

(52) U.S. Cl. CPC C01B 3/48; C01B 3/56; C01B 2203/042; C01B 2203/0233; C01B 2203/0811; C01B 2203/0283

(57) ABSTRACT

The present invention describes a process for steam reforming natural gas, comprising a steam reforming exchanger-reactor (3000), a reactor for converting CO to CO₂ (3100), and a PSA hydrogen purification unit (4300), with a view to producing a synthesis gas in which the heat necessary for the steam reforming reaction is supplied by a first combustion chamber (3100) connected to a second combustion chamber (3200) generating fumes in order to produce a very high degree of thermal integration.

### CONTEXT OF THE INVENTION

The HyGenSys process is a process for the production of hydrogen from methane. The basic principle and the principal characteristics of the process are primarily provided in the patent EP 2 447 210. The original feature of this mode of hydrogen production resides in a very specific exchanger-reactor both from the point of view of mechanical design and compactness and from the point of view of the advanced thermal integration which it authorizes and which results in substantial energy savings. This advanced thermal integration means that a steam consumption can be obtained which is completely adjusted to the requirements of said process, in contrast to the majority of prior art processes which are often steam exporters, and indeed over a wide range of S/C ratio (abbreviation of the molar ratio of steam to the hydrocarbon feed, in this case natural gas).

This feature constitutes a very important advantage insofar as the sites which are capable of accommodating a unit for the production of hydrogen by steam reforming of methane (the abbreviation of which is SMR, namely “Steam Methane Reforming”), such as oil refineries, often have surplus steam and there is no advantage in accommodating a producer of more steam.

### EXAMINATION OF THE PRIOR ART

The patent EP 2 447 210 describes the basic flowsheet for the process of hydrogen production by steam reforming natural gas, known as the “HyGenSys” process which will be outlined briefly below:

The heat necessary for the methane steam reforming reaction, which is highly endothermic, is supplied by pressurized fumes produced by a combustion chamber principally supplied with purge gas from the hydrogen purification step (PSA, abbreviation of the English term Pressure Swing Adsorption”), and with a makeup fuel.

After reacting at high temperature, the residual heat from the fumes is exploited in the form of steam which supplies the process and a turbine which drives the air compressor necessary for the production of fumes under pressure. This mode of operation is particularly suitable for the claimed preferred range of the (molar) ratio of steam to hydrocarbon feed of between 1.5 and 2. However, SMR units are routinely operated with excess steam with a (molar) ratio of steam to carbon in the range 2 to 4 (S. Reyes et al., Ind. Eng. Chem. Res., Vol. 42, No. 8, 2003).

The process in accordance with the present invention involves a second combustion chamber and has an even more advanced thermal integration, which means that the possible range of operation of the steam reforming exchanger-reactor of the “HyGenSys” process can be extended.

The advantage of the second combustion chamber is also to make the process more flexible, both as regards the level of start-up and as regards operation, and also as regards the type of natural gas treated. Because of the second combustion chamber, the thermal integration described in the present invention can be used to optimize the configuration in order to maximize the energy yield of the installation.

### BRIEF DESCRIPTION OF THE FIGURES

FIG. 1 represents a first configuration of the process in accordance with the invention, with the primary combustion chamber and the secondary combustion chamber operating in series.

FIG. 2 represents a second configuration of the process in accordance with the invention, in which the secondary combustion chamber is not in series but generates fumes which are then mixed with those from the primary combustion chamber in order to generate an overall stream of reheated fumes.

FIG. 3 represents a third configuration of the process in accordance with the invention, in which the secondary combustion chamber operates in parallel to the principal combustion chamber and generates an independent stream of fumes which is not mixed with the stream of fumes obtained from the primary combustion chamber.
In the remainder of the text, the term “first combustion chamber” will be used for the primary combustion chamber, and “second combustion chamber” for the secondary combustion chamber, the descriptor “primary” indicating that the fumes generated in the primary chamber or first combustion chamber supply the heat to the catalytic steam reforming exchanger-reactor.

### BRIEF DESCRIPTION OF THE INVENTION

The present invention may be considered to be an improvement to the process for the production of synthesis gas by steam reforming natural gas as described in the patent EP 2 447 210.

The improvement introduced essentially consists of adding a second combustion chamber in order to generate a stream of reheated fumes which, in fact, can be used to increase the production of superheated steam for the process, and thus provide access to a wider range of S/C molar ratio than in the prior art. This S/C molar ratio range is thus widened to an interval of 1.5 to 5, and preferably 2 to 4.

More precisely, the present invention may be defined as a process for steam reforming natural gas using a steam reforming exchanger-reactor (3000), a reactor for the conversion of CO to CO₂ (3001), usually termed a WGS reactor (Water Gas Shift), and a unit for the purification of hydrogen by PSA (4300), with a view to producing a synthesis gas in which the heat necessary for the steam reforming reaction is provided by combustion fumes generated in a first pressurized combustion chamber (3100) supplemented by a second combustion chamber (3200) which is connected in series or in parallel with respect to the first combustion chamber, in a manner such as to produce a stream of steam in an exchanger (1007) with said fumes obtained from the first and second combustion chambers, in order to accommodate both the requirements for steam for the steam reforming reaction and those for the steam turbine (6000) in order to supply the air compressor (5200), said steam generated by the process being used to obtain S/C molar ratios at the steam reforming exchanger-reactor (3000) in the range 1.5 to 5, and preferably in the range 2 to 4.

The present invention can be broken down into three variations as a function of the way in which the second combustion chamber is connected to the first combustion chamber generating the hot fumes for the process.

In a first variation of the present process, the second combustion chamber is supplied with the fumes obtained from the first combustion chamber and raises their temperature levels.

In a second variation of the present invention, the second combustion chamber operates independently of the first combustion chamber and the fumes generated by said second chamber combine with those generated by the first combustion chamber.

In a third variation of the present invention, the second combustion chamber also operates independently of the first combustion chamber and the fumes generated by said second combustion chamber follow a path which is independent of that for the fumes obtained form the first combustion chamber.

In accordance with the first variation of the present invention, the invention may be defined as a process for steam reforming natural gas with a view to producing a synthesis gas (sometimes known as “syngas”), in which the heat necessary for the steam reforming reaction is supplied by the combustion fumes generated in a first combustion chamber (3100) operating at a pressure in the range 1.5 to 4 bar, and preferably in the range 2 to 3 bar.

Said fumes are introduced into the steam reforming exchanger-reactor (3000) at a temperature in the range 950° C. to 1300° C., and give up their heat to the process fluid in the steam reforming exchanger-reactor. They leave the exchanger-reactor (3000) at a temperature in the range 450° C. to 750° C., then are reheated in a second combustion chamber (3200) using a makeup fuel in order to raise their temperature level to a value in the range 450° C. to 1250° C., the level of temperature of which allows steam to be generated in an exchanger (1007) with said reheated fumes in a manner such as to accommodate both the requirements for steam for the steam reforming reaction on the one hand and those for the steam turbine (6000) in order to supply the air compressor (5200) on the other hand. The steam generated during the various heat exchanges of the process can be used to obtain S/C ratios in the steam reforming exchanger-reactor (3000) in the range 1 to 5, and preferably in the range 2 to 4.

In accordance with the second variation of the process for steam reforming natural gas in accordance with the invention, the heat necessary for the steam reforming reaction is supplied by combustion fumes generated in a first combustion chamber (3100) operating at a pressure in the range 1.5 to 4 bar, and preferably in the range 2 to 3 bar, said fumes being introduced into the steam reforming exchanger-reactor (3000) at a temperature in the range 950° C. to 1300° C. Said fumes give up their heat to the process fluid in the steam reforming exchanger-reactor (3000) and leave the exchanger-reactor at a temperature in the range 450° C. to 750° C., then rejoin the fumes (440) obtained from a second combustion chamber (3200) in a manner such as to produce a stream of mixed and reheated fumes (441) the temperature of which is in the range 450° C. to 1250° C. This level of temperature allows steam to be generated in an exchanger (1009) with said reheated fumes (441) in a manner such as to accommodate both the requirements for steam for the steam reforming reaction and those for the steam turbine (6000) in order to supply the air compressor (5200). The steam generated during the process can be used to obtain S/C ratios in the steam reforming exchanger-reactor in the range 1 to 5, and preferably in the range 2 to 4.

In accordance with the third variation of the natural gas steam reforming process in accordance with the invention, the heat necessary for the steam reforming reaction is supplied by combustion fumes generated in a first combustion chamber (3100) operating at a pressure in the range 1.5 to 4 bar, and preferably in the range 2 to 3 bar, said fumes being introduced into the steam reforming exchanger-reactor (3000) at a temperature in the range 950° C. to 1300° C. Said fumes give up their heat to the process fluid in the steam reforming exchanger-reactor (3000) and leave the exchanger-reactor at a temperature in the range 450° C. to 750° C., forming a first stream of fumes (410),
said first stream of fumes (410) obtained from the exchanger-reactor (3000) is introduced into the exchanger (1007) in a manner such as to superheat the incoming stream of steam (630) so as to produce a stream of superheated steam (631) and a stream of cooled fumes (415) which is supplied to the exchange zone (1009) in order to preheat the combustion air (301), from which a stream of reheated compressed air (310) and a stream of cooled fumes (416) is produced, said cooled fumes (416) being at a pressure in the range 1 to 2 bar and at a temperature in the range 130° C. to 300° C.,
the second stream of fumes (450) obtained from the second combustion chamber (3200) operating in parallel to the first combustion chamber (3100) is at a temperature in the range 900° C. to 1500° C., preferably in the range 950° C. to 1300° C., and at a pressure in the range 1.5 to 4 bar, said second stream of fumes (450) is supplied to the heat exchanger (1008) in contact with a stream of boiler water (730) in order to vaporize a fraction (731) therein, resulting in a stream of partially vaporized steam (731) and partially cooled fumes (451), said stream of cooled fumes (451) being introduced into the exchanger (1010) in order to produce a stream of reheated boiler water (511), the cooled stream of fumes (452) being at a pressure in the range 1 to 2 bar and at a temperature in the range 130° C. to 300° C.

In a preferred version, which is valid for the three variations of the natural gas steam reforming process in accordance with the invention, the fuel which is primarily used in the first combustion chamber (3100) is constituted by the purge gas from the unit for PSA purification of synthesis gas obtained from the steam reforming exchanger-reactor.

In a version which is also preferred, which is valid for the three variations of the natural gas steam reforming process in accordance with the invention, the makeup fuel used in the first combustion chamber (3100) is a light fuel gas which is available on site.

When a fuel of this type is not available, natural gas may be used, optionally the same natural gas as that used for the feed for the steam reforming exchanger-reactor (3000).

This fuel may also be used in the second combustion chamber (3200) and preferably, the primary chamber (3100) and the secondary chamber (3002) use the same fuel.

### DETAILED DESCRIPTION OF THE INVENTION

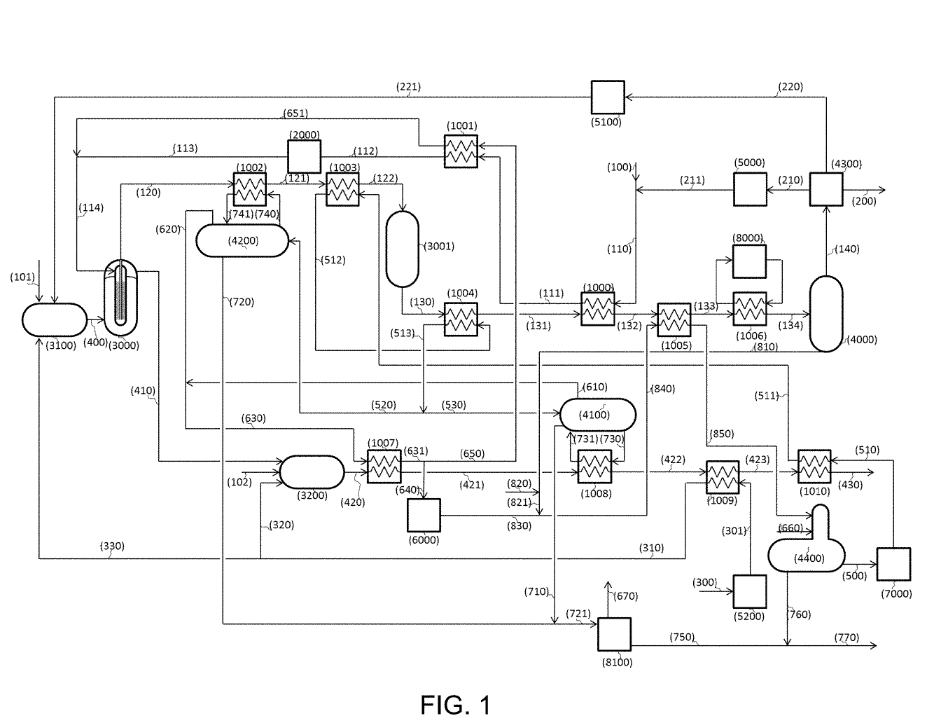

The following detailed description pertains to FIG. 1 which represents the preferred version of the operational flow sheet according to the invention.

The exchangers in FIG. 1 are represented by way of indication. When a particular configuration of an exchanger is preferred, it is specified in the detailed description.

The pressures are expressed in bar absolute, denoted as bar.

Several circuits can be distinguished in the present flowsheet:
the natural gas feed circuit (100),
the circuit for the synthesis gas effluent resulting in the production of hydrogen (200),
the circuit for fumes (400) produced in the principal combustion chamber (3100),
the circuit for fumes (420, 440, 450) produced in the secondary combustion chamber (3200) respectively in accordance with the three preferred variations of the present steam reforming process,
the circuit for hydrogen obtained from the PSA (220).

The present operational flowsheet in its 3 variations results in a very strong thermal integration, in particular as regards the fumes circuit.

The present flowsheet is designed to minimize the external heat which is supplied to the principal combustion chamber (3100) and the secondary combustion chamber (3200).

It is also designed such that the unit is flexible as regards the steam introduced with the feed in the sense that the process may be operated with ratios of steam to feed (denoted S/C) in the range 1.5 to 5, and preferably in the range 2 to 4.

For a given steam reforming catalyst, there is a great importance in using S/C ratios which are as high as possible in order to reduce the risk of coking at the tubes of the steam reforming reactor and to facilitate the subsequent WGS reaction.

The process is supplied with natural gas (100) at a pressure of the order of 30 to 42 bar depending on the pressure drop induced by the exchanger-reactor itself and the other associated exchangers.

Optionally and depending on the choice of catalytic operation selected to desulphurize the feed (2000) a stream of hydrogen (211) obtained from the production unit of purified H₂ (4300) is mixed with the feed (100). Typically, this makeup of hydrogen is in the range 1% to 10% of the molar stream of the feed (100), preferably in the range 2% to 7%.

The function of this makeup of hydrogen is to promote the conversion of sulphur-containing molecules which might possibly be contained in the feed (100) into H₂S which is captured by the capture masses contained in 2000. This results in a stream of natural gas enriched in hydrogen (110).

The hydrogen-enriched feed (110) is reheated in a heat exchanger (1000) in contact with a process stream (i.e. obtained from the process) which is the stream (131) (synthesis gas) which has already been partially cooled (131). The function of this exchange is to preheat the feed a first time in order to economise on the heat to be provided to the exchanger-reactor (3000).

The stream of partially cooled synthesis gas (131) is at a temperature which is typically in the range 160° C. to 220° C. The feed enriched in hydrogen is intended to be reheated to a temperature equal to at least 130° C., preferably at least equal to 140° C. For this exchange of heat (1000), a counter-current configuration is preferred. The feed enriched in hydrogen and reheated a first time (111) is reheated a second time in a heat exchanger (1001). Here, the feed is reheated using a stream of superheated steam (650).

The function of this second reheating is to preheat the feed in a manner such that its temperature is compatible with the desulphurization (2000) located downstream. Reheating is envisaged to a temperature in the range 300° C. to 400° C., preferably in the range 330° C. to 380° C.

The temperature of the superheated steam (650) is in the range 440° C. to 500° C.

The hydrogen-enriched and superheated feed (112) is then desulphurized in the desulphurization unit (2000). Desulphurization serves to protect the active phases of the reforming catalyst (for example metallic nickel) from sulphur, which greatly reduces their activity. This desulphurization step necessarily includes capture masses to trap the sulphur. These masses are, for example, constituted by fixed beds of zinc or copper oxide. Depending on the sulphur-containing species encountered in the feed, and in particular to treat the case of sulphur-containing odorants used in natural gas, it may be necessary to precede these capture masses with a catalytic hydrogenation, the function of which is to convert the sulphur-containing species which are refractory to capture on the guard beds into sulphur-containing species which can be captured, such as H₂S (not shown in FIG. 1). As indicated above, the presence of hydrogen in the feed favours this catalytic step.

The sulphur specification at the outlet from the desulphurization step is generally below the ppm level. In the case of feeds containing very little sulphur, cold capture masses may be employed, for example with nickel, in order to desulphurize the feed. In this case, they are located as close as possible to the end bank, typically on the stream 100 (not shown).

The desulphurized feed (113) is then mixed with a stream of steam (651). Here, a H₂O/C molar ratio in the range 1.5 to 5 is envisaged, preferably in the range 1.5 to 3 in the case of a normal regime. A ratio of 1 corresponds to the stoichiometry of the reforming reaction; a ratio of more than 2 allows the reforming reactions to be favoured as well as preventing the appearance of coke on the catalyst of the exchanger-reactor.

The feed mixed with steam (114) is then introduced into the exchanger-reactor (3000). Its temperature is in the range 300° C. to 450° C., preferably in the range 330° C. to 400° C. The preheated feed mixed with steam (114) is introduced into the process tube of the exchanger-reactor (3000); this tube contains a catalyst which is adapted to reactions for steam methane reforming. Typically, its active phase comprises nickel.

The exchanger-reactor (3000) is the seat for a series of equilibrated reactions mainly corresponding to methane reforming (SMR, the abbreviation for Steam Methane Reforming) and to the water gas reaction (WGS, the abbreviation for Water Gas Shift), which is the reaction transforming the mixture of CO+H₂O into CO₂+H₂).

The SMR reaction is highly endothermic, and the conversion of methane by this equilibrated reaction is favoured at high temperatures. In contrast, the WGS reaction is exothermic.

The overall balance of these reactions (SMR and WGS) under the operating conditions selected, i.e. an outlet temperature from the catalytic bed in the range 800° C. to 1000° C., a pressure in the range 25 to 35 bar, is endothermic overall. The heat necessary for the reactions is supplied by the hot fumes under pressure (400) obtained from the principal combustion chamber (3100).

The fumes (400) are at a temperature in the range 950° C. to 1300° C. and at a pressure in the range 1.5 to 4 bar, preferably in the range 2 to 3 bar.

It passes through the exchanger-reactor as a counter-current to the feed (114) in the annular interstitial space between the process tube and the fumes tube which guides the fumes in contact with the process tube it surrounds.

The aim of this exchange is to reach the temperature intended for the reaction at the bottom of the process tube, the counter-current arrangement meaning that exploitation of the high temperature heat energy of the fumes (400) is optimized.

The crude synthesis gas produced by the equilibrated SMR and WGS reactions is evacuated via a bayonet tube which rises through the centre of the process tube and then passes through the catalytic zone located between the external process tube and the internal process tube, the set of the two tubes forming the bayonet tube. Here again, a counter-current exchange of heat is generated between the hot synthesis gas and the feed, meaning that exploitation of the high temperature heat energy supplied to the exchanger-reactor (3000) is optimized.

This results in a partially cooled synthesis gas (120), typically to between 500° C. and 750° C., and a stream of cooled fumes (410), typically between 450° C. and 700° C.

The crude synthesis gas (120), often termed “syngas”, is at a high temperature and under pressure and includes a high hydrogen content, typically between 40 and 60 mol %.

Because temperature conditions between 400° C. and 900° C. are favourable to metal dusting of certain steels, it is desirable to get away from this range as quickly as possible. This is carried out in the exchanger 1002, the function of which is both to rapidly cool the crude synthesis gas (120) in order to leave the range of conditions which are favourable to said metal dusting, but also to exploit the heat transported by the synthesis gas into pressurized steam.

This generation of steam under pressure is carried out between the stream of crude synthesis gas (120) and a stream of boiler water at its bubble point obtained from the steam generation drum (4200). This results in a synthesis gas (121) which has typically been cooled to between 10° C. and 50° C. above the boiling point of the boiler water (740).

By way of example, this boiling point is of the order of 250° C. for a boiler water pressure of the order of 40 bar, and a partially vaporized boiler water stream (741) typically with a degree of vaporization in the range 5% to 25%.

The generally gravitational arrangement of the elements 4200 and 1002 is known to the person skilled in the art to generate steam. Suitable materials, for example ceramics, in the exchanger (1002) are used to prevent any risk of degradation due to metal dusting.

The stream (121) still contains a certain quantity of carbon monoxide, typically between 1% and 20%, which may be converted into hydrogen in a WGS reactor. For a certain CO content, for example of the order of 10% or less, the CO may be converted by a single stage of low temperature WGS.

The synthesis gas (121) reaches a temperature suitable for it to enter the WGS reactor (3001) by an exchange of heat at 1003 with preheated boiler water (511) over its reheating pathway upstream of the steam generation drums (4100 and 4200). The temperature of the synthesis gas (122) at the inlet to the WGS reactor (3001) is typically in the range 200° C. to 300° C., preferably in the range 200° C. to 230° C.

For higher CO contents, a step for higher temperature WGS may have to be carried out instead of or in combination with a low temperature WGS (not shown).

The WGS reaction in the reactor 3001 is exothermic. This results in a synthesis gas which is rich in hydrogen (130) with a CO content which has been reduced to below 5 mol %, and with a temperature which has been increased by about 70° C. to 150° C.

This increase in temperature is intimately linked to the operating conditions of the reactors (3000 and 3001), but also to the initial composition of the feed and its degree of steam dilution.

The heat from the WGS reaction is exploited by a heat exchanger (1004) with reheated boiler water (512) obtained from a first reheating upstream of the WGS reactor.

The function of the exchanger (1004) is to bring the boiler water to a temperature which is suitable for feeding to the steam generation drums (4100 and 4200), i.e. 5° C. to 50° C. below the bubble point of the boiler water present in these drums. This produces a stream of preheated boiler water (513) and a stream of synthesis gas (131).

The other function of the exchanger (1004) is to bring about a drop in temperature aimed at condensing the water contained in the synthesis gas, the condensation being carried out in the exchangers 1000, 1005 and 1006 with a view to tackling the step for purification of the gas (4100).

A liquid fraction might appear in the synthesis gas from the exchanger (1000). This liquid fraction could advance with the synthesis gas to the separator drum (4000) or be evacuated gradually and combine with the condensates (840) of the process upstream of the exchanger 1005.

As indicated above, the synthesis gas reheats the feed (110) in the exchanger 1000 to produce the stream 132.

The synthesis gas is then cooled by a heat exchanger (1005) in contact with the condensates from the process (840). This produces a cooled synthesis gas (133) and condensates (850) reheated to between 90° C. and 130° C., preferably between 100° C. and 110° C. This temperature is selected so as to ensure that the deaerator (4400) operates properly at its operational pressure, generally in the range 1 to 2 bar.

The cooled synthesis gas (133) downstream of the exchanger (1005) is still at a temperature in the range 100° C. to 200° C. for a pressure of the order of 25 to 35 bar. These conditions are insufficient to ensure condensation of the moisture in the gas. Thus, it is supplemented by cooling using a cold utility composed of a heat exchange zone (1006) and optional recirculation of cooled heat transfer fluid connected to a regeneration device (8000).

Typically, there is no need for a regeneration unit (8000) if the heat exchanger (1006) corresponds to an air-cooled exchanger. If the exchanger (1006) corresponds to cooling by circulation of cooling water, the element (8000) may then be a cooling tower.

The choice of exchanger (1006) is generally dictated by the climactic conditions at the installation site, but especially by the maximum water content in the synthesis gas admissible by the purification step (4300), typically less than 10000 ppm by weight.

This produces a cooled synthesis gas (134) at a temperature which is typically less than 50° C. The condensates (810), mainly aqueous, are separated in the separator drum (4000). A synthesis gas (140) is obtained which is rich in dry hydrogen.

The next step at 4300 consists in separating the species present in order to obtain a hydrogen which is more than 95% pure, preferably more than 98%. This separation step is generally carried out by means of a process using the principle of pressure swing absorption (PSA).

The effluents from this step are 3 in number:
a stream of purified hydrogen for exporting (200),
a stream of purified hydrogen for recycling to the process (210),
a purge stream (220) mainly containing the products obtained from conversion other than hydrogen, as well as unconverted species.

The purified hydrogen stream for exporting (200) is at a pressure in the range 20 to 30 bar and at a temperature close to the temperature of separation at 4000.

The pressure of the stream of purified hydrogen for recycling (210) is raised by means of a compression step (5000) in order to be able to reset the pressure drops of the process and be channeled (211) towards the feed entering the unit (100). The PSA purge stream (220) is produced at low pressure, typically between 1 and 3 bar. The pressure is raised during a compression step (5100) so as to be able to channel it (221) towards the primary combustion chamber (3100) which is operated under pressure.

The process in accordance with the invention also includes a steam circuit, the function of which is both to supply the process and to exploit the heat obtained from the process by proposing a solution for driving an air compressor. The system is supplied with boiler water via the line 500. This water is at low pressure and below its boiling point. Its pressure is raised using pumps (7000) so that it is at a higher pressure in (510) than the pressure of the steam generation drums, taking into account the pressure drops over its path, i.e. typically between 40 and 60 bar.

The stream (510) is reheated in a heat exchanger (1010) with the cooled fumes (423). This produces cold fumes (430) at a temperature in the range 110° C. to 200° C., and a stream of reheated boiler water (511) at a temperature in the range 110° C. to 170° C.

The boiler water (511) is reheated again by an exchange of heat with the crude synthesis gas (121) in order to bring the latter to a temperature which is compatible with the desired operation of the WGS reactor (3001).

The boiler water (512) is reheated a final time in the exchanger (1004) before being supplied to the steam generation drums by an exchange with the synthesis gas (130) obtained from the WGS reactor (3001). The aim of this exchange is to bring the boiler water (513) to a temperature in the range 5° C. to 50° C. of the boiling point in the drums (4100 and 4200).

This boiler water is split into two streams (530 and 520) to respectively supply the steam generation drums (4100 and 4200).

The drum 4100 is connected to the heat exchanger 1008 via the conduits 730 and 731. The boiler water contained in the drum (4100) is generally at its bubble point. The conduit 730 channels the boiler water towards the heat exchange zone (1008) where a fraction of the water is vaporized.

The partially vaporized boiler water (731) returns to the steam generation drum (4100) in which the steam fraction is evacuated (610) in order to supply the steam network of the unit.

The liquid fraction is recycled to the drum (4100). The loss of level linked to the production of steam is compensated for by a continuous supply of boiler water (530).

The driving force for the circulation loop constituted by the streams 730 and 731 is generally gravitational. In general, multiple conduits 730 and 731 may be used.

The drum 4200 is connected to the heat exchanger 1002 via conduits 740 and 741. In general, the boiler water contained in the drum (4200) is at its bubble point. The conduit 740 channels the boiler water towards the heat exchange zone (1002) where a fraction of the water is vaporized. The partially vaporized boiler water (741) returns to the steam generation drum (4200) from which the steam fraction is evacuated (620) to be supplied to the steam network of the unit. The liquid fraction is recycled to the drum (4200). The loss of level linked to the production of steam is compensated for by a continuous supply of boiler water (520).

The driving force for the circulation loop constituted by the streams 740 and 741 is generally gravitational. In general, and as is known to the person skilled in the art, multiple conduits 740 and 741 may be used. The steam generators 4100 and 4200 produce a similar quality of steam with the operational point being of the order of 40 bar with a temperature of the order of 250° C.

The operational range for the steam generators is between 35 and 60 bar with a degree of vaporization for the streams 731 and 741 in the range 5% to 25%.

The steam streams 610 and 620 are combined at 630 so as to be superheated in 631 in a heat exchanger (1007) in contact with the hot fumes (420) obtained from the secondary combustion chamber (3200).

The superheated steam (631) is divided between the supply (640) for the turbine (6000) and the supply (650) to the process. The prime function of the superheated steam supplying the process (650) is to preheat the feed during the heat exchange (1001) described above. It is then mixed (651) with the desulphurized feed (113) in order to constitute the supply (114) to the exchanger-reactor (3000).

The stream of superheated steam (640) supplies the turbine (6000) which can be used to drive the rotary machines of the unit, and in particular the air compressor (5200). The connection between the turbine (6000) and the compressor (5200) is not shown in FIG. 1.

The expansion turbine is connected, for example, to a cooling circuit to condense the expanded steam (not shown). This condensation has a dual function: it generates a partial vacuum downstream of the turbine, which improves the expansion yield and thus the recoverable work at its shaft, and it can also be used to be able to recycle (830) the condensates in the boiler water circuit (the elements such as pumps for moving these condensates are not shown).

The circuit for recycling the boiler water includes recovering the condensates (810) from the process obtained from the condensation of the moisture contained in the synthesis gas upstream of the purification unit (4300), a water makeup (820), preferably adapted to boiler use, and of the demineralized type, for example, which are combined (840) with the condensates (830). These condensates (840) are reheated (1005) by an exchange of heat with the partially cooled synthesis gas (132). The reheated condensates (850) are expanded and sent to the degasser (4400), the function of which is to eliminate the dissolved gases which, like CO₂ with its acidifying action, could perturb or degrade the boiler water circuit. The operating principle consists of stripping the condensates with low pressure steam (660).

Another control element regarding the quality of water consists of continuously removing a fraction of the boiler water in the various capacities constituting the boiler water network (4100, 4200 and 4400). For the capacities under temperature and at pressure such as the steam generation drums (4100 and 4200), these takeoffs (respectively 710 and 720) represent of the order of 1% to 10%, preferably 1% to 5% of the supply stream for the boiler water capacities.

These are cooled (8100) so that they can be at a temperature adapted to their treatment, typically below 50° C. On the scale of a SMR unit, these streams are large and it may be advantageous to expand these hot condensates (721) (not shown upstream of cooling) in order to produce low pressure steam (670) which may, for example, be suitable for stripping (660) the boiler water in the degasser (4400). The residual liquid stream itself is cooled. The degasser (4400) may also include a continuous takeoff (760), in particular to control the amount of solid contained in the boiler water. The effluents (750 and 760) are charged with impurities, and so they are directed (770) towards a water treatment unit (not shown).

The energy necessary for reforming natural gas is supplied by pressurized fumes. Air (300) is pressurized by a compressor (5200), preferably driven by the steam turbine (6000). The compressed air (301) is at a pressure in the range 2 to 5 bar. Preferably, the air is preheated by heat exchanger (1009) with the partially cooled fumes (422). The stream of reheated air (310) is typically between 200° C. and 300° C.

The preheated air is divided between the air supply (330) for the principal combustion chamber (3100) and the supply (320) to the secondary combustion chamber (3200).

This division is optional if, depending on the technology selected, such as with gas duct burners, the combustion can be carried out with the residual oxygen contained in the hot fumes (410) in the secondary combustion chamber (3200).

The principal combustion chamber is supplied with compressed and reheated air (330), the purge from the purification unit (4300), which is then recompressed (221), as well as with a makeup of fuel (101). This fuel makeup is necessary in the event that the energy released by the combustion of the purge (221) does not supply sufficient energy to ensure that it alone can operate the exchanger-reactor (3000) properly.

The makeup fuel (101) is preferably gaseous and, as an example, 101 is selected to use the same natural gas as that acting to supply the process (100).

Depending on the selected site, it is possible that this could have surplus light fuel gases such as, for example, refinery fuel gas, in which case these fuels are preferred for all or part of the supply to the combustion chambers, the makeup possibly being carried out with the natural gas acting to supply the process.

The principal combustion chamber (3100) produces fumes (400) at a pressure in the range 1.5 to 4 bar, preferably between 2 and 3 bar, which pass through the exchanger-reactor (3000) as a counter-current to the feed (114) then leave the exchanger-reactor (410) at a temperature in the range 450° C. to 750° C.

They receive a complement of energy in the second combustion chamber (3200) by combustion of a makeup fuel (102) of the same type as 101.

The supply of oxygen to the secondary combustion chamber (3200) is carried out for all or a portion by the residual oxygen contained in 410, with a supplement of preheated pressurized air (320). In certain cases, this combustion air for the secondary combustion chamber (3200) will be compressed by a compressor which is independent of the compressor (5200) which is dedicated to said secondary combustion chamber. The supply for this compressor of the secondary combustion chamber could be electrical or it could use steam. This disposition provides the process with more flexibility. This produces a stream of reheated fumes (420) at a temperature in the range 450° C. to 1250° C. the function of which is to superheat the steam in the exchanger (1007) and generate steam in the exchanger (1008) in a manner such that the overall production of steam from the drums (4100 and 4200) covers the steam requirement of the process, and preferably the steam requirement of the process and that for the supply to the turbine (6000) in order to drive the compressor (5200).

These exchanges produce cooled fumes (422) at a temperature in the range 5° C. to 50° C. above the bubble point of the boiler water contained in the steam generation drum (4100).

In the case of a bubble point of the order of 250° C., this produces a cooled fumes temperature in the range 255° C. to 300° C.

This temperature level means that the air in the heat exchanger (1009) can be preheated. This produces fumes (423) the temperature of which is typically in the range 130° C. to 250° C., which means that the boiler water in the heat exchanger (1010) can be reheated a first time. This produces cold fumes (430) at a temperature in the range 110° C. to 200° C.

Two simplified versions of the present flowsheet exist, in which either the step for preheating the combustion air from the combustion chambers via the exchanger (1009) is dispensed with, or in which the step for recovering energy on the superheated steam (6000) is dispensed with, the compressor (5200) then being driven by any means known to the person skilled in the art.

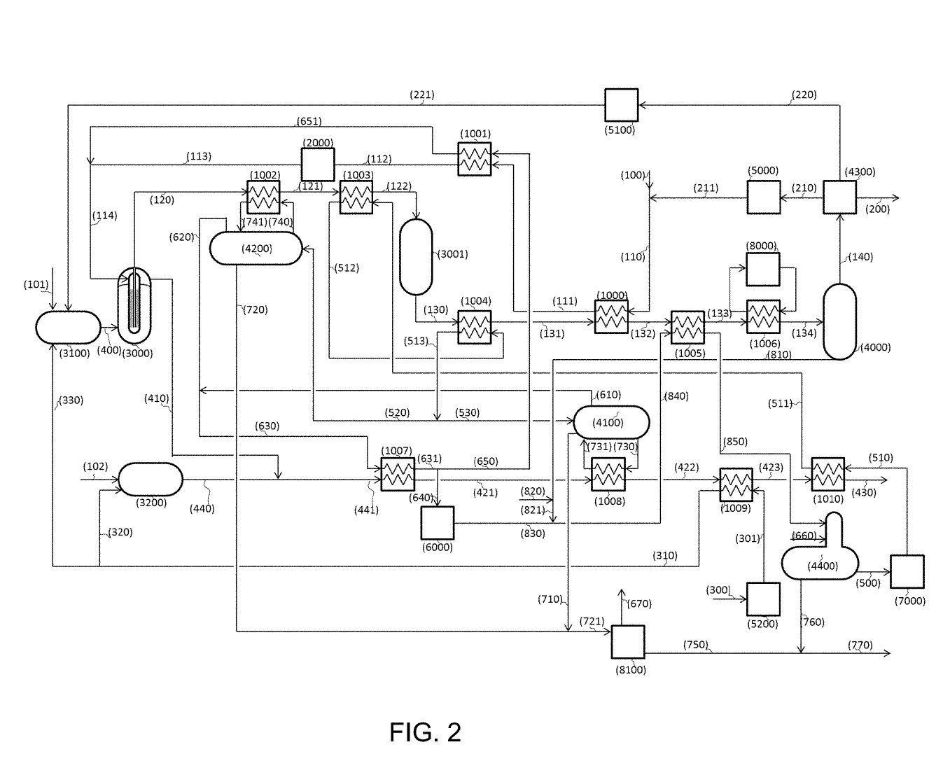

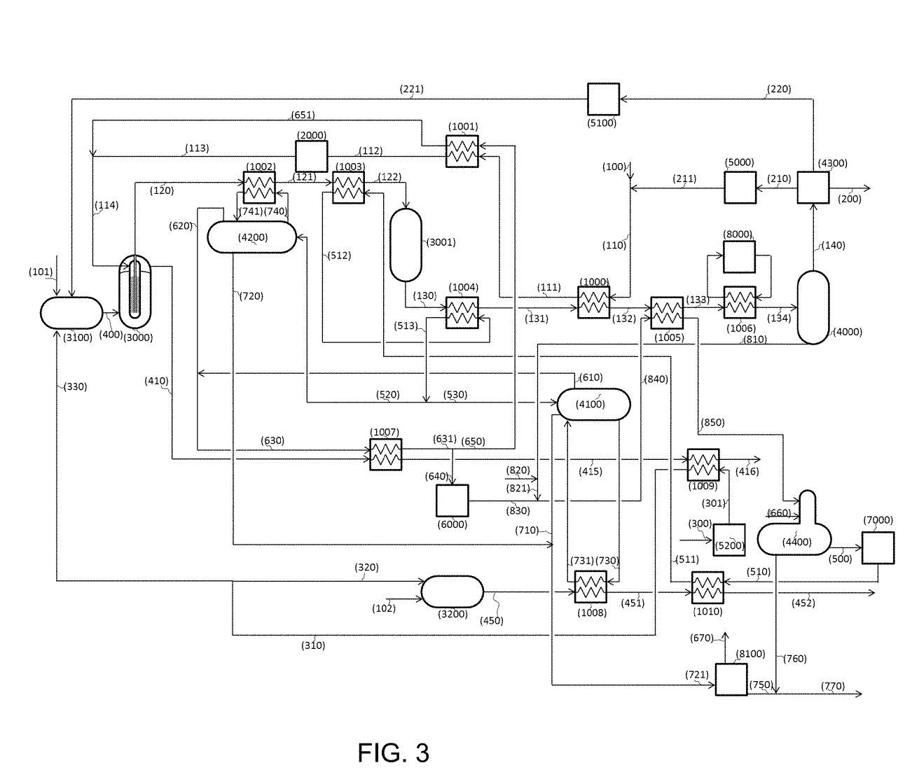

### FIG. 2

The description of FIG. 2 is the same as the description of FIG. 1, with the exception of the generation of superheated fumes (410) downstream of the exchanger-reactor.

The combustion chamber (3200) is supplied with pressurized air (320) and with fuel (102) as described above. In contrast, it is no longer supplied with the fumes (410) obtained from the exchanger-reactor (3000). The secondary combustion chamber (3200) thus operates independently of the principal combustion chamber (3100) and generates a stream of hot fumes (440) which is mixed with the fumes (410) in a manner such that the stream of mixed fumes (441) has characteristics comparable with the stream (420) described above (FIG. 1). The fumes (440) are at a temperature in the range 650° C. to 1800° C., preferably in the range 900° C. to 1300° C., so as to produce a stream of mixed fumes (441) the temperature of which is in the range 450° C. to 1250° C.

The mixed fumes (441) then undergo the exchanges described above in the exchangers (1007, 1008, 1009 and 1010).

### FIG. 3

The description of FIG. 3 is the same as the description of FIG. 1, with the exception of the management of the generation of hot fumes and exploiting their heat.

In the same manner as in the variation described in FIG. 2, the principal (3100) and secondary (3200) combustion chambers are operated in an independent manner.

The difference here is that the two combustion chambers, principal and secondary, operate in parallel, and that the fumes obtained from each of the chambers are not combined. The exchange train is distributed over the corresponding two streams of fumes.

The stream of fumes (410) obtained from the exchanger-reactor (3000) is as described above. In this variation, the fumes obtained from the exchanger-reactor (3100) are introduced directly into the exchanger (1007), in a manner such as to superheat the stream of steam (630). Preferably, the exchanger (1007) operates in counter-current mode. This produces a stream of superheated steam (631) as described in FIG. 1 and a stream of cooled fumes (415).

This stream of cooled fumes (415) is supplied to the exchange zone (1009) to preheat the combustion air (301). This produces a reheated compressed air (310) as described above for FIG. 1, and a stream of cooled fumes (416). These cooled fumes (416) are at a pressure in the range 1 to 2 bar and at a temperature in the range 130° C. to 300° C.

The stream of fumes (450) obtained from the second combustion chamber (3200) is at a temperature in the range 900° C. to 1500° C., preferably in the range 950° C. to 1300° C., and at a pressure in the range 1.5 to 4 bar. The fumes (450) are supplied to the heat exchanger (1008) in contact with a boiler water stream (730) to vaporize a fraction (731) as described above.

This produces a stream of partially vaporized steam (731) and cooled fumes (451).

The stream of cooled fumes (451) exchanges heat with the boiler water (510) in the exchanger (1010) in order to produce a stream of reheated boiler water (511) as described above.

This produces a stream of cooled fumes (452) at a pressure in the range 1 to 2 bar and at a temperature in the range 130° C. to 300° C.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding application No. FR 1656017, filed Jun. 28, 2016 are incorporated by reference herein.

### EXAMPLES IN ACCORDANCE WITH THE INVENTION

The two examples below are intended to demonstrate the operation of a hydrogen production unit in accordance with the invention, and in particular the role played by the secondary combustion chamber in the flexibility of the unit.

Example 1 pertains to the preferred configuration illustrated in FIG. 1 for a steam/natural gas (S/C) molar ratio of 2.

Example 2 pertains to the preferred configuration illustrated in FIG. 1 for a S/C ratio of 4.

### Example 1

This example considers a steam reforming unit integrating the “HyGenSys” steam reforming exchanger-reactor in accordance with the configuration shown in FIG. 1.

The production was 100000 Nm³/h of hydrogen with a purity of 99.8 mol %.

The feed considered was a natural gas containing 150 ppm of sulphur-containing species the composition of which is shown in Table 1, in molar fractions.

The natural gas feed (100) was supplied to the process at a rate of 29.7 t/h. It was operated at a steam to carbon (S/C) molar ratio in the feed of 2.

TABLE 1

| Species | Molar fractions |
|---|---|
| CO₂ | 0.012 |
| CH₄ | 0.920 |
| C₂H₆ | 0.043 |
| C₃+ | 0.011 |
| N₂ | 0.014 |

The exchanger-reactor was supplied with this feed after adding 0.18 t/h of H₂ obtained from production, i.e. the purge from the PSA (4300), desulphurization and mixing with 63.7 t/h of steam. The resulting synthesis gas (120), after a WGS step (3001), was cooled to 40° C. (134) in order to obtain 19.7 t/h of condensate before PSA purification (4300). This resulted in purification by PSA of a stream of 9.2 t/h of H₂ (200), a stream of 0.18 t/h of H₂ (210) intended for the feed, and a purge of the order of 64.6 t/h (220) destined for the principal combustion chamber (3100).

The principal combustion chamber (3100) was supplied with recompressed purge gas (221), compressed air (330) in an amount of 342 t/h and makeup fuel (101) with the same composition as the feed gas in an amount of 0.48 t/h.

The combustion produced 407 t/h of hot pressurized fumes (400).

The secondary combustion chamber (3200) was supplied with cooled fumes (410), 3.9 t/h of air (320) and with 0.39 t/h of makeup fuel (102).

This produced a stream of 412 t/h of reheated fumes (420).

52.7 t/h of steam 620 and 58.3 t/h of steam 610 were produced by heat exchange with synthesis gas (120) and with reheated fumes (421) respectively.

For a total of 111 t/h of steam produced, 63.7 t/h was intended for the process (650), and 43.7 t/h was intended for a turbine (6000) to drive the air compressor (5200).

In this configuration, it was not useful to recycle the heat from the fumes by reheating the combustion air.

### Example 2

This example considers a steam reforming unit integrating the HyGenSys reactor in accordance with the configuration shown in FIG. 1.

The same capacity and the same feed composition as in Example 1 were used.

The production was 100000 Nm³/h of hydrogen with a purity of 99.8 mol %.

The feed under consideration was a natural gas containing 150 ppm of sulphur-containing species the composition of which is shown in Table 1 as molar fractions. The feed (100) was supplied to the process in an amount of 22.8 t/h. It was operated at a steam to carbon (S/C) molar ratio of 4.

The exchanger-reactor (3000) was supplied with this feed after adding 0.15 t/h of H₂ obtained from the production, i.e. the purge from the PSA (4300), desulphurization and mixing with 100 t/h of steam.

The resulting synthesis gas (120), after a WGS step (3001), was cooled to 40° C. (134) in order to obtain 55.4 t/h of condensate before PSA purification (4300).

This resulted in purification of a stream of 9.2 t/h of H₂ (200), 0.15 t/h of H₂ (210) intended for the feed, and a purge (220) of the order of 58.4 t/h destined for the principal combustion chamber (3100).

The principal combustion chamber (3100) was supplied with recompressed purge gas (221), compressed air (330) in an amount of 320 t/h and makeup fuel (101) with the same composition as the feed gas in an amount of 5.1 t/h.

The combustion in the principal chamber (3100) produced 383 t/h of hot pressurized fumes (400).

The secondary combustion chamber (3200) was supplied with cooled fumes (410), 26.8 t/h of air (320) and with 2.6 t/h of makeup fuel (102). This produced a stream of 412 t/h of reheated fumes (420).

63.6 t/h of steam 620 and 83.1 t/h of steam 610 were produced by heat exchange with synthesis gas (120) and with reheated fumes (421) respectively.

For a total of 147 t/h of steam produced, 100 t/h was intended for the process (650), and 46.7 t/h was intended for a turbine (6000) to drive the air compressor (5200).

In this configuration, the heat from the fumes was recycled by reheating the combustion air with a heat flow of the order of 10 MW, providing a saving of the order of 0.8 t/h of makeup gas.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A process for steam reforming natural gas using a steam reforming exchanger-reactor (3000), a reactor for the conversion of CO to CO₂ (3001), termed a WGS reactor, and a unit for the purification of hydrogen by PSA (4300), with a view to producing a synthesis gas which is gradually enriched with hydrogen in the WGS (3001) and purification (4300) units, in which the heat necessary for the steam reforming reaction is provided by combustion fumes generated in a first pressurized combustion chamber (3100) supplemented by a second combustion chamber (3200) which is connected in series or in parallel with respect to the first combustion chamber, in a manner such as to produce a stream of steam in an exchanger (1007) with said fumes obtained from the first and second combustion chambers, in order to accommodate both the requirements for steam for the steam reforming reaction and those for the steam turbine (6000) in order to supply the air compressor (5200), and said steam generated by the process being used to obtain S/C molar ratios at the steam reforming exchanger-reactor (3000) in the range 1.5 to 5, and preferably in the range 2 to 4.

2. The natural gas steam reforming process as claimed in claim 1, in which the heat necessary for the steam reforming reaction is supplied by combustion fumes generated in a first combustion chamber (3100) operating at a pressure in the range 1.5 to 4 bar, and preferably in the range 2 to 3 bar, said fumes being introduced into the steam reforming exchanger-reactor (3000) at a temperature in the range 950° C. to 1300° C., said fumes giving up their heat to the process fluid in the steam reforming exchanger-reactor and leaving the exchanger-reactor (3000) at a temperature in the range 450° C. to 750° C., then being reheated in a second combustion chamber (3200) using a makeup fuel in a manner such as to raise their temperature level to a value in the range 450° C. to 1250° C., which level of temperature allowing steam to be generated in an exchanger (1007) with said reheated fumes in a manner such as to accommodate both the requirements for steam for the steam reforming reaction and those for the steam turbine (6000) in order to supply the air compressor (5200).

3. The natural gas steam reforming process for the production of a synthesis gas as claimed in claim 1, in which the heat necessary for the steam reforming reaction is supplied by combustion fumes generated in a first combustion chamber (3100) operating at a pressure in the range 1.5 to 4 bar, and preferably in the range 2 to 3 bar, said fumes being introduced into the steam reforming exchanger-reactor (3000) at a temperature in the range 950° C. to 1300° C., said fumes giving up their heat to the process fluid in the steam reforming exchanger-reactor and leaving the exchanger-reactor (3000) at a temperature in the range 450° C. to 750° C., then rejoining the fumes (440) obtained from a second combustion chamber (3200) in a manner such as to produce a stream of mixed fumes (441) the temperature of which is in the range 450° C. to 1250° C., which level of temperature allowing steam to be generated in an exchanger (1009) with said reheated fumes, in a manner such as to accommodate both the requirements for steam for the steam reforming reaction and those for the steam turbine (6000) in order to supply the compressor (5200).

4. The natural gas steam reforming process for the production of a synthesis gas as claimed in claim 1, in which the heat necessary for the steam reforming reaction is supplied by combustion fumes generated in a first combustion chamber (3100) operating at a pressure in the range 1.5 to 4 bar, and preferably in the range 2 to 3 bar, said fumes being introduced into the steam reforming exchanger-reactor (3000) at a temperature in the range 950° C. to 1300° C., said fumes giving up their heat to the process fluid in the steam reforming exchanger-reactor (3000) and leaving the exchanger-reactor at a temperature in the range 450° C. to 750° C., forming a first stream of fumes (410),
said first stream of fumes (410) obtained from the exchanger-reactor (3000) being introduced into the exchanger (1007) in a manner such as to superheat the incoming stream of steam (630) so as to produce a stream of superheated steam (631) and a stream of cooled fumes (415) which is supplied to the exchange zone (1009) in order to preheat the combustion air (301), from which a stream of reheated compressed air (310) and a stream of cooled fumes (416) is produced, said cooled fumes (416) being at a pressure in the range 1 to 2 bar and at a temperature in the range 130° C. to 300° C.,
the second stream of fumes (450) obtained from the second combustion chamber (3200) operating in parallel to the first combustion chamber (3100) being at a temperature in the range 900° C. to 1500° C., preferably in the range 950° C. to 1300° C., and at a pressure in the range 1.5 to 4 bar, said second stream of fumes (450) being supplied to the heat exchanger (1008) in contact with a stream of boiler water (730) in order to vaporize a fraction (731) therein, producing a stream of partially vaporized steam (731) and partially cooled fumes (451), said stream of cooled fumes (451) being introduced into the exchanger (1010) in order to produce a stream of reheated boiler water (511), the cooled stream of fumes (452) being at a pressure in the range 1 to 2 bar and at a temperature in the range 130° C. to 300° C.

5. The natural gas steam reforming process as claimed in claim 1, in which the fuel which is used in the first combustion chamber (3100) is primarily constituted by the purge gas from the unit for PSA purification of synthesis gas obtained from the steam reforming exchanger-reactor.

6. The natural gas steam reforming process as claimed in claim 1, in which a makeup fuel is used in the first combustion chamber (3100), said fuel being a light fuel gas which is available on-site.

7. The natural gas steam reforming process as claimed in claim 1, in which the makeup fuels used in the first and the second combustion chamber are identical.
